(19) United States
(12) Patent Application Publication
(10) Pub. No.: US 2013/0227620 A1
(43) Pub. Date: Aug. 29, 2013

(54) Wireless Transmission Set Top Box

(71) Applicant: Chien-Chin Chen, Taipei (TW)

(72) Inventor: Chien-Chin Chen, Taipei (TW)

(21) Appl. No.: 13/406,132

(22) Filed: Feb. 27, 2012

(51) Int. Cl. H04N 21/40

(52) U.S. Cl. 725/81

(57) ABSTRACT

A wireless transmission set top box, comprising: a box body, a plurality of circuit boards, a power supply and radiator module; of which the box body consists of a connecting zone for interfacing with external mobile communication device; a plurality of circuit boards are located within the box body, and comprised of a plurality of electronic circuit components and a wireless transmission module, allowing to provide wireless transmission signals to the display for showing the control signals of the mobile communication device.

### BACKGROUND OF INVENTION

1. Field of the Invention

The present invention relates generally to a wireless transmission set top box (STB), and more particularly to one which transmit control signals from mobile communication device to the display so as to generate high-definition pictures

2. Description of Related Art

The universal connecting terminals for wired HDMIs or all sorts of mobile communication devices are inconvenient in use, and such wired connection is highly restricted by certain operating space and transmission distance. For example, HDMI transmission line provided. for LCD TV and LCD display is only 5-10 m in length.

In addition, said translation efficiency and quality of display will be affected by the transmission distance. 720P for existing BOX STB causes some delay in utilization of WIFI 2.4 GHZ, so there is a room for improvement by the relevant operators.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The primary objective of the present invention is to provide a wireless transmission STB, which comprising: a box body, a plurality of circuit boards, power supply and radiator module; of which the box body consists of a connecting zone for interfacing with the mobile communication device; a plurality of circuit boards are located within the box body, and comprised of a plurality of electronic circuit components and a wireless transmission module, allowing to provide wireless transmission signals to the display for showing the control signals of the mobile communication device; a plurality of circuit boards also consist of a communication circuit board, a charge/discharge circuit board and a signal control circuit board connected with the mobile communication device, whilst the signal control circuit board consists of a signal conversion chip; said power supply is located in the box body and connected with the circuit board, so as to supply power required for the radiator module and wireless transmission module; the radiator module is located in the box body and connected with the power supply.

Based on this design, the wireless transmission SIB is connected with the mobile communication device; when it is intended for use, the control signals of the mobile communication device are transmitted from the wireless transmission module of the wireless transmission STB to the display; namely, the control signals operated directly by the operators on the mobile communication device could be indicated graphically on the display, allowing for networking, watching films or playing games, and also avoiding fatigue of eyes or short sight.

### BRIEF DESCRIPTION OF THE DRAWINGS

FIG. 1: a perspective view of the present invention.

FIG. 2: an exploded view of the present invention.

FIG. 3: a block diagram of the present invention.

### DETAILED DESCRIPTION OF THE INVENTION

The purposes and advantages of the present invention will be more readily understood upon a thoughtful deliberation of the following detailed description of the preferred embodiment of the present invention with reference to the accompanying drawings. And, the preferred embodiment along with its structure is described in detail with other possible configurations.

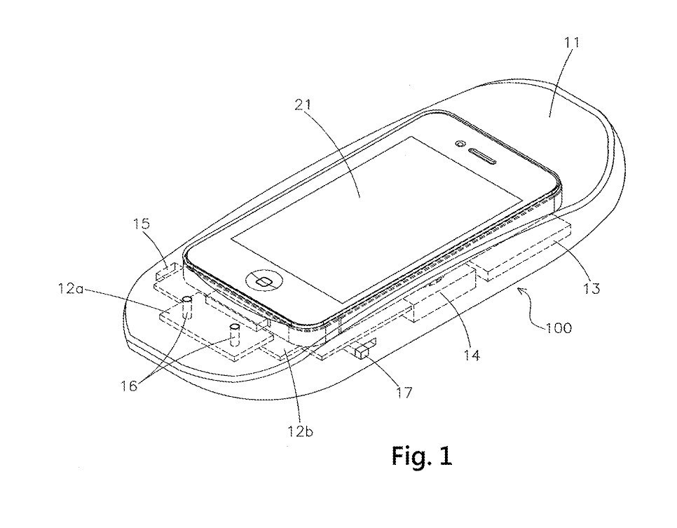

FIG. 1 depicts a preferred embodiment of the present invention, which, however, is provided for only explanatory objective for patent claims.

The wireless transmission STB 100, comprising: a box body 11, a plurality of circuit boards 12, power supply 13 and radiator module 14.

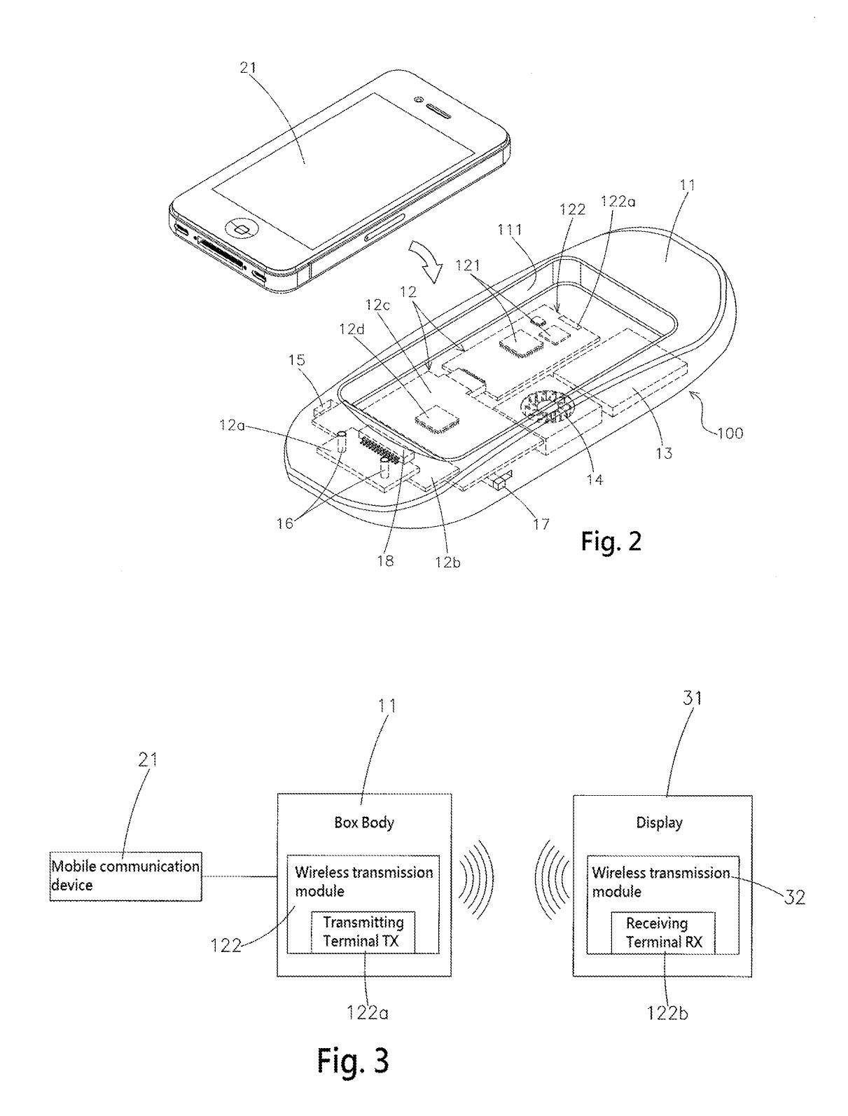

Referring to FIGS. 2, 3, the dimension of the box body 11 of the present invention is slightly bigger than that of common mobile communication device 21, namely, the box body 11 can be held and carried easily, since it is dimensionally compatible with PSP or equivalents; the box body 11 consists of a grooved connecting zone 111, which allows to place or position the mobile communication device 21 (e.g.: various communication products) for the purpose of interfacing with the mobile communication device 21;

a plurality of circuit boards 12 (5 IC boards are described hereto, but not limited to this amount) are located within the box body 11; winding lines could be set on a plurality of circuit boards 12; the circuit board 12 also consists of a port 18, and the connecting zone 111 on the box body 11 is connected with the mobile communication device 21; in addition, the circuit board 12 consists of a plurality of electronic circuit components 121 (e.g.: control chip and processor), of which a plurality of circuit boards 12 consist of a communication circuit board 12a, a charge/discharge circuit board 12b and a signal control circuit board 12c connected with the mobile communication device 21, whilst the signal control circuit board 12b consists of a signal conversion chip 12d;

a plurality of circuit boards 12 also consist of a wireless transmission module 122 with WHDI technology in line with wireless HD video networking criterion; with this criterion, uncompressed HD wireless networking is made possible to transmit video data through 5 GHz license-exempt frequency band, at 40 MHz and 3 Gbps (inclusive of 1080 p/60 Hz) in line with 5 GHz universal spectrum criterion; based on the transmission range exceeding 100 m and delay less than 1 ms, the wireless signals from wireless transmission module 122 could penetrate wall to external display 31 showing the control signals of the mobile communication device 21; it is worthy to note that, the wireless transmission module 122 (WHDI) of STB is provided with a transmitting terminal TX 122a, and the wireless transmission module 32 of the display 31 provided with a receiving terminal RX 122b; the wireless transmission SIB 100 could convert the signals of the mobile communication device 21 (e.g. various communication products) into video ones, allowing for wireless transmission to the receiving terminal RX 122b of the display 31 by the transmitting terminal TX 122a;

the power supply 13 of big capacity is located in the box body 11 and connected with the circuit board 12, so as to energize the wireless transmission STB 100, e.g.: supplying power required for the radiator module 14 and wireless transmission module 122;

the radiator module 14 herein is referred to as an exhaust fan, which is located in the box body 11 and connected with the power supply 13, so as to discharge heat source of relevant electronic circuit components 121 on the circuit board. 12;

the wireless transmission STB 100 of the present invention also consists of a charging port 15 connected. with the circuit board 12; one end of the charging port 15 is exposed to the box body 11 with power line connections; here, the charging port 15 is a micro usb or equivalent;

the wireless transmission STB 100 of the present invention also consists of a plurality of indicators 16 connected with the circuit board 12; here, a plurality of indicators 16 are referred to as either power indicators or charging indicators, which could indicate the operating status by checking the sufficiency of the power supply;

the wireless transmission STB 100 of the present invention also consists of a switchgear 17 connected with the circuit board 12; one end of the switchgear 17 is exposed to the box body 11, enabling the users to control manually on/off of the wireless transmission STB 100;

the wireless transmission STB 100 of the present invention allows the mobile communication device 21 to be embedded directly onto the box body 11, or inserted onto the connecting zone 111 of the box body 11 by means of assembly; when it is intended for use, the control signals of the mobile communication device 21 are transmitted from the transmitting terminal TX 122a of the wireless transmission module 122 (WHDI) to the receiving terminal RX 122b of the wireless transmission module 32 of the display 31; after the wireless transmission module 32 of the display 31 receives the control signals, these signals operated directly by the operators on the mobile communication device 21, such as: networking, watching films or playing games, could be indicated graphically on the display 31; in detail, the pictures on the mobile communication device 21 could be input to the wireless transmission STB 100 and shown on the display 31 with highest level of graphical quality 1080 P, with the maximum wireless transmission distance up to 10 m˜25 m; this could avoid fatigue of eyes or short sight of the children or adults;

if smart mobile phones are combined with the wireless transmission STB of the present invention, the pictures could be viewed directly from big-screen and HD displays. Meanwhile, the mobile communication device is inserted onto the wireless transmission STB, so users are allowed to operate flexibly on the mobile communication device, the pictures of the mobile communication device could be received and converted by the wireless transmission STB, and then displayed on LCD TV and LCD display.

To sum up, the present invention provides an innovative product not yet made publicly available, hence the following claims are made with respect to the utility patent in conformity with relevant regulations. However, it should be appreciated that the present invention is capable of a variety of embodiments and various modifications by those skilled in the art, and all such variations or changes shall be embraced within the scope of the following claims.

1. A wireless transmission set top box, which comprising:
a box body, consisting of a connecting zone for interfacing with an external mobile communication device;
a plurality of circuit boards, located within the box body, and consisting of a plurality of electronic circuit components and a wireless transmission module, allowing to provide wireless transmission signals to the display for showing the control signals of the mobile communication device;
a power supply, located within the box body and connected with the circuit board; and
a radiator module, located within the box body and connected with the power supply.

2. The wireless transmission set top box as claimed in claim 1, wherein said set top box further comprises a charging port connected with the circuit board.

3. The wireless transmission set top box as claimed in claim 1, wherein said set top box further comprises a plurality of indicators connected with the circuit board.

4. The wireless transmission set top box as claimed in claim 1, wherein said set top box further comprises a switchgear connected with the circuit board.

5. The wireless transmission set top box as claimed in claim 1, wherein said circuit board also consists of a port located on the connecting zone of the box body.

6. The wireless transmission set top box as claimed in claim 1, wherein said circuit board consists of a communication circuit board, a charge/discharge circuit board and a signal control circuit board connected with external mobile communication device.

7. The wireless transmission set top box as claimed in claim 6, wherein said signal control circuit board consists of a signal conversion chip.
